(19) United States
(12) Patent Application Publication
(10) Pub. No.: US 2025/0252724 A1
(43) Pub. Date: Aug. 7, 2025

(54) SYSTEMS, METHODS AND APPARATUSES OF AUTOMATED FLOOR AREA MEASUREMENT FROM THREE-DIMENSIONAL DIGITAL REPRESENTATIONS OF EXISTING BUILDINGS

(71) Applicant: INTEGRATED PROJECTS TECHNOLOGY INC., East Orange, NJ (US)

(72) Inventors: Thomas CZERNIAWSKI, East Orange, NJ (US); Theodore WEBER, East Orange, NJ (US); Austin COROTAN, East Orange, NJ (US)

(21) Appl. No.: 19/048,016

(22) Filed: Feb. 7, 2025

Related U.S. Application Data
(60) Provisional application No. 63/550,776, filed on Feb. 7, 2024.

(51) Int. Cl. G06V 10/82; G06T 7/62; G06T 15/20; G06V 10/26; G06V 10/774

(52) U.S. Cl. CPC G06V 10/82; G06T 7/62; G06T 15/20; G06V 10/26; G06V 10/774; G06T 2207/10024; G06T 2207/20081; G06T 2207/20084; G06T 2207/20132; G06T 2207/30184; G06T 2210/12; G06T 2210/22

(57) ABSTRACT

A system and method are disclosed for estimating the floor area of an existing building from a 3D digital representation. Various embodiments can leverage reality capture devices, such as LIDAR laser scanners or photogrammetry techniques, to obtain 3D representations. The 3D representations may be segmented using artificial neural networks, isolating individual floors. These segmented floors may be projected into 2D and processed through another neural network to yield a precise binary representation differentiating between floor and non-floor areas. The resulting binary images allow for the computation of the total floor area in square footage for each level.

### CROSS-REFERENCE TO RELATED APPLICATIONS

This application claims the benefit of priority pursuant to 35 U.S.C. § 119 (e) of U.S. Provisional Patent Application No. 63/550,776, filed Feb. 7, 2024, entitled “Systems, Methods and Apparatuses of Automated Floor Area Measurement From Three-Dimensional Digital Representations of Existing Buildings,” which is hereby incorporated by reference herein in its entirety.

### BACKGROUND

Models of buildings may be used for informed decision-making. Building models can help stakeholders visualize the structure, layout, and characteristics of a building before construction begins. These models provide a realistic representation of the building's appearance, enabling architects, engineers, and designers to assess aesthetics, spatial arrangements, and identify potential design flaws or improvements. Building models can facilitate accurate planning and analysis of various aspects, such as space utilization and energy efficiency.

Models play an important role in determining the layout of machines within a facility. Models allow decision-makers to optimize the placement of machines within a given space. By creating a virtual representation of the facility, including accurate measurements and machine specifications, decision-makers can experiment with different layouts to identify the most efficient arrangement. This helps maximize space utilization, minimize wasted areas, and ensure optimal workflow and accessibility.

Building models can assist in retrofitting existing structures and planning for their maintenance. Decision-makers can evaluate different retrofitting approaches, predict the impact of modifications, and plan maintenance schedules more efficiently, ultimately extending the lifespan of the building.

Due to these benefits and more, the use of virtual models has become increasingly desirable. However, the process of generating a virtual model can be costly, challenging, and time-consuming.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example process flow diagram of digitizing an existing building using reality capture device in accordance with some embodiments.

FIG. 2 illustrates an example process flow diagram for a floor area estimator to detect building levels from a 3D digital representation in accordance with some embodiments.

FIG. 3 illustrates an example process flow diagram for a floor area estimator to calculate floor area for each building level from the 3D digital representation in accordance with some embodiments.

FIG. 4 illustrates a perspective view of a 3D digital representation of a level of an existing building in accordance with some embodiments.

FIG. 5 illustrates an example of a color element of a 2D plan view projection in accordance with some embodiments.

FIG. 6 illustrates an example of a vertical point density element of a 2D plan view projection in accordance with some embodiments.

FIG. 7 illustrates an example of an item element of a 2D plan view projection in accordance with some embodiments.

FIG. 8 illustrates an example of how a 2D plan view projection may be cropped into different sections for processing by an artificial neural network in accordance with some embodiments.

FIG. 9 illustrates an example process flow diagram for transforming a building information model into a floor area mask in accordance with some embodiments.

FIG. 10 illustrates an example of a training performed using a crop of a 2D plan view projection generated from a point cloud as an input and a corresponding crop generated from a building information model as an output in accordance with some embodiments.

FIG. 11 illustrates an example of a set of crops being reconstituted into a 2D semantically segmented mask of a building level in accordance with some embodiments.

FIG. 12 illustrates an example of quantifying floor area based on a 2D semantically segmented mask in accordance with some embodiments.

FIG. 13 illustrates a method for a floor area estimator in accordance with some embodiments.

FIG. 14 is a block diagram of a floor area estimator in accordance with some embodiments.

### DETAILED DESCRIPTION

Models of homes, commercial office buildings, apartments, and other facilities are used by various stakeholders involved in the construction, design, and real estate industries. Additionally, owners and tenants of the buildings may use such a model for renovations, layout optimization, and design. These models can be used to help communicate ideas and ensure optimal use of available space.

In some cases, a virtual three-dimensional (3D) model may not exist for a building, or the virtual 3D model may be outdated. Advances in 3D scanning technology has allowed 3D scans and images of a building to be captured and visual representations to be generated. This visual representation may be useful to see what the space looks like. However, the 3D scan does not provide critical information (e.g., floor area) to convert the 3D scans into accurate models.

Accordingly, it may be desirable to convert these 3D scans to accurate models with architectural, mechanical, and furniture information. As the prevalence of these 3D scans increase, such a system may be able to ingest point cloud information from 3D scans of homes, skyscrapers, schools, hospitals, etc., and convert such point clouds into accurate 3D and 2D models. For instance, a system may convert the point cloud into a Computer-aided design (CAD) or Building Information Modeling (BIM) file.

As part of this conversion process, embodiments herein may extract accurate floor areas from a 3D scan or point cloud. Converting the 3D scan or point cloud into an accurate floor area measurement is pivotal in a models creation. For example, accurate floor area measurement provides essential information for spatial planning within a building. Further, floor area measurement is a critical factor in lease and rental agreements. Additionally, floor area measurement is a key factor in property valuation. Accurate floor area measurements ensure the effective utilization of space and transparency in various aspects of building design, management, and transactions. This conversion of data from one form of output from a 3D scanning device to another format that is more accessible may assist engineers, architects, and other decision makers.

Currently, the conversion from a 3D scan to a model with an accurate floor area is done manually. This manual process is time consuming, requires a significant amount of skill, and is costly. For example, an operator may manually create a digital representation of a building and trace out the areas that they want to include within that area. Not only is this time consuming, it may also lead to inaccuracies.

Embodiments herein provide an automated approach to determine an accurate floor area measurement from a 3D scan or point cloud. The floor area is a metric on which a lot of decision making is made. To do this, embodiments herein may use artificial neural networks to determine an accurate floor area measurement.

Embodiments herein describe systems, apparatuses, and methods for determining the floor area of buildings from digital 3D representations. The digital 3D representations may be a scan or point cloud of an existing building. Example embodiments may leverage reality capture devices, such as LIDAR laser scanners or photogrammetry techniques, to create a 3D digital representation of the building. An artificial neural network, or other suitable methods, may be used to process this 3D representation. The artificial neural network may segment the representation so that each floor of the building is individually isolated. Each segmented floor may be transformed into a two-dimensional (2D) projection. Another neural network may be used to process the 2D projections. This step may yield a binary representation where pixels (or appropriate 2D elements) are classified as either ‘floor’ or ‘not-floor.’ Using the refined 2D binary representations, a system may calculate the total square footage of the floor area for each level of the facility.

There are a few issues that a system may face when converting a 3D scan to a floor area measurement. First, the system should be able to detect what is interior space versus exterior space. In many cases, the data from a 3D scan can include exterior spaces (e.g., landscaping, parking lots, and other surrounding area). Embodiments herein may use an artificial neural network to exclude the exterior spaces from the floor area measurement. Further, there may also be noise within the input data. For instance, reflections may be created when a laser from a scanning device interacts with reflective surfaces like glass and metal. Embodiment herein may discriminate between the noise and the actual data in its determination of the floor area measurement.

Embodiments herein describe a floor area estimator. The floor area estimator may use a series of artificial neural networks to convert a 3D digital representation of a building into accurate floor area measurements for each level of a building.

Embodiments may be understood by reference to the drawings, wherein like parts are designated by like numerals throughout. It will be readily understood by one of ordinary skill in the art having the benefit of this disclosure that the components of the embodiments, as generally described and illustrated in the figures herein, could be arranged and designed in a wide variety of different configurations. Thus, the following more detailed description of various embodiments, as represented in the figures, is not intended to limit the scope of the disclosure, but is merely representative of various embodiments. While the various aspects of the embodiments are presented in drawings, the drawings are not necessarily drawn to scale unless specifically indicated.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

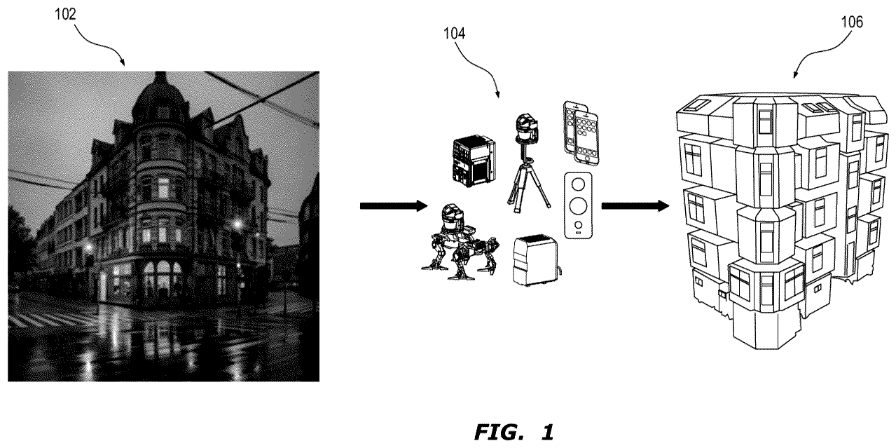

Turning to the drawings, FIG. 1 illustrates an example process flow diagram of digitizing an existing building 102 using reality capture device 104 in accordance with some embodiments. Creating the 3D digital representation 106 of the building 102 offers numerous benefits and reasons why someone would want to undertake such a project. For example, the 3D digital representation 106 can provide a visually rich and interactive way to communicate the design, layout, and characteristics of a building. It allows stakeholders, such as architects, engineers, developers, and clients, to better understand and visualize the proposed structure, fostering effective communication and collaboration.

To create the 3D digital representation 106, individuals may use one or more reality capture devices 104. Possible reality capture devices 104 may include terrestrial Light Detection and Ranging (LiDAR) laser scanning devices, mobile LiDAR laser scanning devices, smartphones, tablets, wearable LiDAR devices, and photo and video based photogrammetry devices.

In some embodiments, the reality capture device 104 may output a point cloud. A point cloud output by the reality capture device 104 is a collection of 3D coordinates that represent individual points in space. Each point in the point cloud corresponds to a specific position in the surveyed area and contains information about the distance, elevation, and sometimes the intensity or color of the reflected laser pulse. The point cloud is generated by LiDAR sensors that emit laser pulses and measure the time it takes for the pulses to bounce back after hitting objects or surfaces in the environment. The LiDAR device captures this information by recording the precise position of each reflected laser pulse, resulting in a dense collection of points in a 3D coordinate system. The point cloud provides a detailed representation of the surveyed area, capturing the shape and geometry of objects, surfaces, and terrain in high precision.

In some embodiments, the point cloud may not include color information. That color information can instead be layered on top of the point measurements by using a camera to collect color imagery. The color information from the camera may be associated with the point measurements to generate the 3D digital representation 106 with color.

In some embodiments, the reality capture device 104 may use photo and video based photogrammetry. Photogrammetry is a technique that uses overlapping photographs taken from different angles to extract accurate 3D information. The output of such a reality capture device 104 may be a mesh model rather than a point cloud. While some embodiments herein may refer to the use of a point cloud, inputs based on photogrammetry may also be used.

Systems, methods, and apparatuses may be able to use the output of the reality capture device 104 to determine a floor area measurement of the 3D digital representation 106. The floor area estimator may be agnostic to the reality capture device 104 or method of digitization, so long as the result is a three-dimensional digital representation of the building 102.

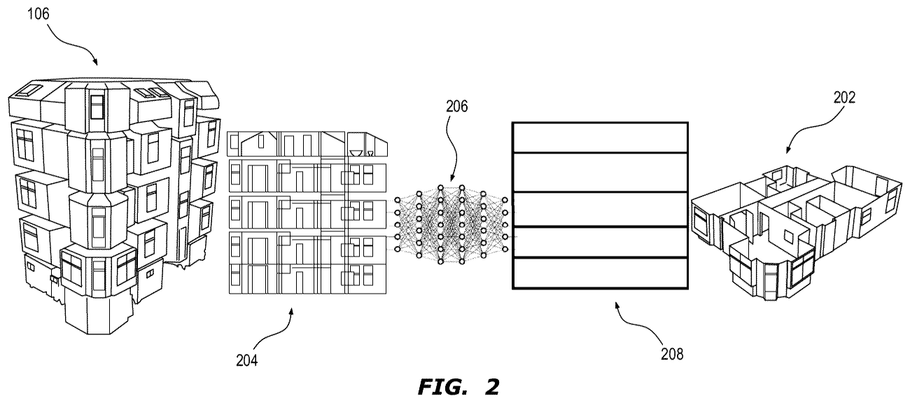

FIG. 2 illustrates an example process flow diagram for a floor area estimator to detect building levels from a 3D digital representation 106. The floor area estimator may process an output from the reality capture device 104 to identify and isolate each building level 202 of the building. The 3D digital representation 106 may be segmented into building levels 202 using a first artificial neural network 206.

In some embodiments, the floor area estimator may project the 3D digital representation 106 of the building is projected to a 2D elevation view 204. The 2D elevation view 204 of the 3D digital representation 106 provides a representation of the vertical faces of the object from a particular viewpoint. It showcases the height, width, and depth of the object, but in a flattened representation. The 2D elevation view 204 used to detect the building levels depicts one side of the 3D digital representation 106, showing its features in a straight-on, two-dimensional format. The 2D elevation view 204 illustrates a horizontal density of the points in the 3D digital representation 106. To obtain the 2D elevation view 204, the floor area estimator may determine the points of the point cloud that are contained within a horizontal column and convert the 3D digital representation 106 into a 2D grayscale intensity image where the color of each pixel is based on the number of points in each horizontal column. As the floors, ceilings, and walls of each building level 202 include a large number of points when viewed from the side of the 3D digital representation 106, the resulting 2D elevation view 204 may highlight such structural elements while reducing the appearance of furniture.

The floor area estimator may use a first artificial neural network 206 to process the 2D elevation view 204. The first artificial neural network 206 may output bounding boxes 208 around each building level 202. The specific architecture of the neural network may vary based on a desired implementation. In some embodiments, the first artificial neural network 206 may use an architecture designed for object detection to detect the building levels 202 and output the bounding boxes 208. For example, in some embodiments, a single-shot detector (SSD), a region-based convolutional neural network (R-CNN), or a You Only Look Once (YOLO) architecture may be used for object detection. The first artificial neural network 206 may divide the 2D elevation view 204 into a grid of cells. For each cell, the first artificial neural network 206 may detect a corresponding level object and predict bounding box coordinates identifying each building level 202.

In some embodiments, the first artificial neural network 206 may have two input channels. The first channel may receive the horizontal density information of the 2D elevation view 204, and the second channel may receive color information of the 2D elevation view 204. The first artificial neural network 206 may use these two channels to identify the floor slabs, walls, and/or ceilings of each building level 202 and generate bounding boxes 208 that identify a range of points for each building level 202. In some embodiments, the first artificial neural network 206 may have a single channel that receives the horizontal density information of the 2D elevation view 204 to identify the floor slabs, walls, and/or ceilings of each building level 202, and generate the bounding boxes 208.

The bounding boxes 208 may define minimum and maximum X and Y coordinates in the 2D elevation view 204 that identify the points in each building level 202. The floor area estimator may extend the bounding boxes across the 3D digital representation 106 to isolate points for each building level 202 of the point cloud of the 3D digital representation 106. The portions of the 3D digital representation 106 delineated by each bounding box 208 may be isolated by the floor area estimator for further processing. The bounding boxes 208 may be used to identify a range within the point cloud of the 3D digital representation 106 that correspond to each building level 202.

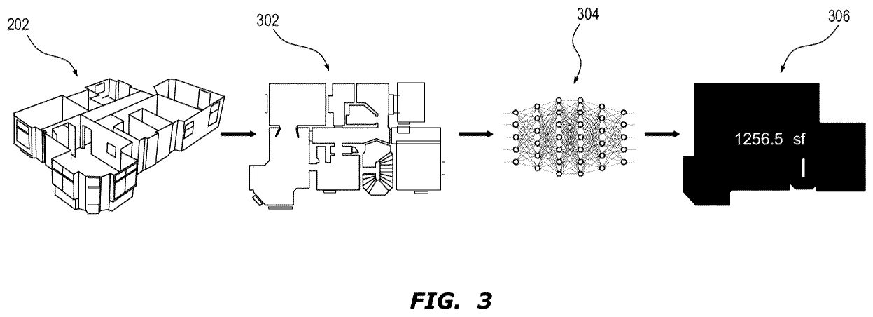

FIG. 3 illustrates an example process flow diagram for a floor area estimator to calculate floor area for each building level 202 from the 3D digital representation 106. The floor area estimator may perform floor area semantic segmentation and measurement on each building level 202 of the 3D digital representation 106. This step of the process involves classifying space into floor area and not floor area, and quantifying the floor area.

The floor area estimator projects the single-level 3D digital building representations (e.g., building level 202) to a 2D plan view 302. The floor area estimator processes the 2D plan view 302 using a second artificial neural network 304 that outputs a 2D semantically segmented mask 306. The second artificial neural network 304 may perform classification and semantic segmentation. It may classify segments of the 2D plan view 302 as floor or not floor and segment the 2D plan view 302 into a mask 306 of the floor area. The architecture of the second artificial neural network 304 may vary based on implementation. For example, in some embodiments, the second artificial neural network 304 may employ DeepLabv3 and ResNet-50.

The second artificial neural network 304 may be used for semantic image segmentation. The second artificial neural network 304 may assign semantic labels to each segment (e.g., pixel) in an image, thereby dividing the image into floor area and not floor area segments based on the information present in each segment. The floor area estimator may input portions (e.g., crops) of the 2D plan view 302 into the second artificial neural network 304, and the second artificial neural network 304 may determine whether segments (e.g., pixels) within each of the portions should be classified as floor area, and performs semantic segmentation on the portions of the 2D plan view 302 to identify regions of floor area and generate the 2D semantically segmented mask 306.

The second artificial neural network 304 may take as inputs, crops of the 2D plan view 302. The second artificial neural network 304 may perform semantic segmentation on each of the crops and piece the crops back together to reconstitute the entire floor plate. The second artificial neural network 304 may generate the 2D semantically segmented mask 306 based on the semantic segmentation. The 2D semantically segmented mask 306 marks regions of the 2D plan view 302 into two categories, floor area and not floor area. The 2D semantically segmented mask 306 provides a view of the floor plate with any area that is not floor area removed.

In some embodiments, the floor area estimator may perform a set of transformations to obtain the 2D plan view 302 to provide to the second artificial neural network 304. For example, the 2D plan view 302 may include color information, density information, and item information. The second artificial neural network 304 may use three channels to digest the different elements of the 2D plan view 302: a color channel, a vertical density channel, and an item channel. To obtain the input for the color channel, the floor area estimator may provide the 2D plan view 302 with all the point cloud and color information for that floor. To obtain the input for the vertical density channel, the floor area estimator may determine the points of the point cloud for the level that are contained within a vertical column and convert the 2D plan view 302 into a grayscale intensity image where the shade of each pixel is based on the number of points in each vertical column. To obtain the input for the item channel, the floor area estimator may determine the points of the point cloud for the level that are less than or equal to a threshold height off of the floor in a vertical column and convert those points to a gray scale intensity image where the shade of each pixel is based on the how close the points are to the threshold height. The second artificial neural network 304 may use the information received via the color channel, a vertical density channel, and an item channel and generate the 2D semantically segmented mask 306. In some embodiments, corresponding pieces of the inputs may be provided to the second artificial neural network 304 to reduce processing demand. The output of each of the pieces may be joined together to generate the 2D semantically segmented mask 306.

In some embodiments, one or more additional artificial neural networks may be used for detection of elements within the 2D plan view 302. For instance, in some standards of floor area measurements, there may be certain inclusion rules and exclusion rules for floor area calculations. For instance, in some standards, rentable square footage does not include parking lots and certain types of storage spaces associated with building services. These types of fine grained categories may be somewhat challenging for the second artificial neural network 304 to identify. Accordingly, another neural network may be trained and employed to detect specific categories of areas to include and exclude based on the inclusion and exclusion rules.

The additional artificial neural networks may provide more control over what is included and excluded in the floor area calculation. This may improve the performance of the floor area estimator. For example, if there is a particular standard that has some unique exclusion categories, another neural network may be added that detects that category of object (e.g., elevators or a certain kind of building penetration).

The segments in the mask 306 representing floor area may be quantified by the floor area estimator to calculate floor area for the building level 202. The floor area estimator may sum the total the floor areas of the individual floors to determine a total floor area for the building 102.

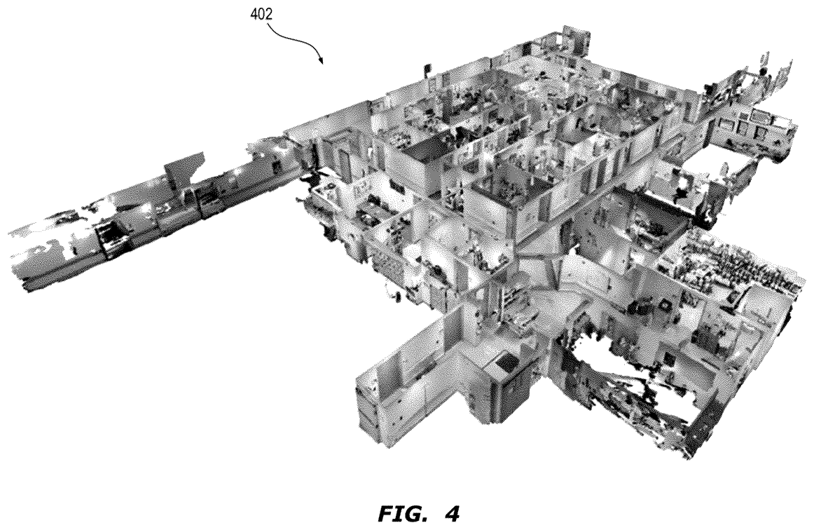

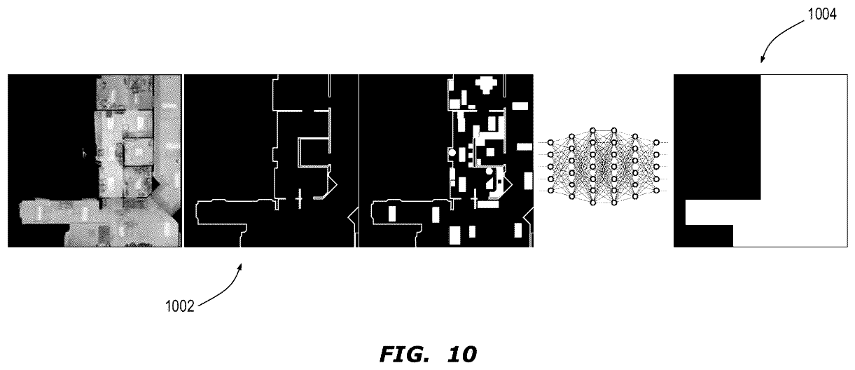

FIGS. 4-9 illustrate details regarding inputs for prompting a floor area prediction from an artificial neural network, or training of the artificial neural network. The inputs described below may be used for generating the semantically segmented mask of each building level to determine a floor area. Additionally, to train the artificial neural network, inputs such as those described below may be used along with corresponding outputs generated from existing building information models (as shown in FIG. 10) may be used as a training dataset.

The artificial neural networks accept an input and produce an output. They are trained to produce the desired output through way of examples. These examples are called the training dataset. The floor area segmentation neural network (e.g., second artificial neural network 304) is trained on a dataset comprising input examples and output examples. The input examples may include 2D plan view projections of single-level 3D digital representations of existing buildings. The output examples may include 2D plan view floor area masks. For the training dataset, this output example may be derived from building information models.

FIG. 4 illustrates a perspective view of a 3D digital representation of a level 402 of an existing building. The 3D digital representation of the level 402 may be obtained from reality capture hardware and level segmentation. Possible inputs to create the 3D digital representation of the building include terrestrial LiDAR laser scanning; mobile LiDAR laser scanning; smartphone, tablet, and wearable device LiDAR; photo and video based photogrammetry. The 3D digital representation of the building may be segmented to generate the levels for the training dataset using a level detection neural network (e.g., first artificial neural network 206).

Inputs to the floor area segmentation neural network may include 2D plan view projections of single-level 3D digital representations of existing buildings. 2D plan view projections may include a color element, a vertical point density element, and an item element for a level. To create the 2D plan view projections, the system may take a point cloud representation of the building level 402, and project it to 2D using several calculation methods (1. Color, 2. Density, and 3. Stuff). These methods may rely on dividing the point cloud into a grid of vertical columns. Each column in this grid is associated with a pixel in the resulting projection image.

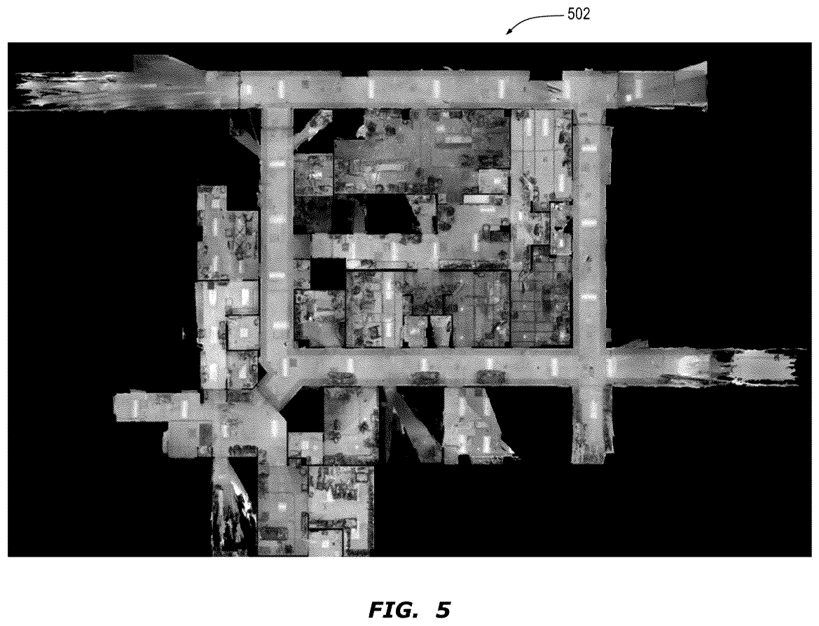

FIG. 5 illustrates an example of a color element 502 of a 2D plan view projection. The color element 502 comprises details regarding the color of the 3D digital representation projected into a 3D view. To generate the color element 502, the system may collect all the points of the point cloud that are contained within a vertical column and average their colors. The average may be used to set the color of the associated pixel in the color element 502 of the 2D plan view projection. The color element 502 may be considered a full x-ray vision transparency projection.

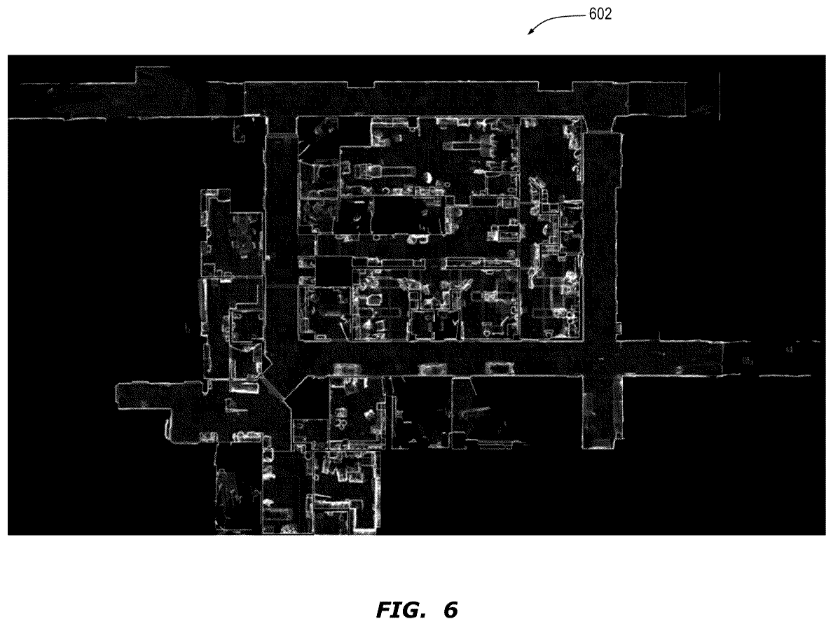

FIG. 6 illustrates an example of a vertical point density element 602 of a 2D plan view projection. To generate the vertical point density element 602, the system may collect all the points of the point cloud that are contained within a vertical column and count them. In some embodiments, the system may then convert the count to grayscale, where black is zero points and white is the maximum number of points found in a vertical column. This grayscale intensity may be used to set the color of the pixel in the resulting vertical point density element 602 projection. Vertical planes, including walls, will show up clearly in the vertical point density element 602. In some embodiments different representations of point density per vertical column may be used (e.g., heat map, color gradient image, etc.).

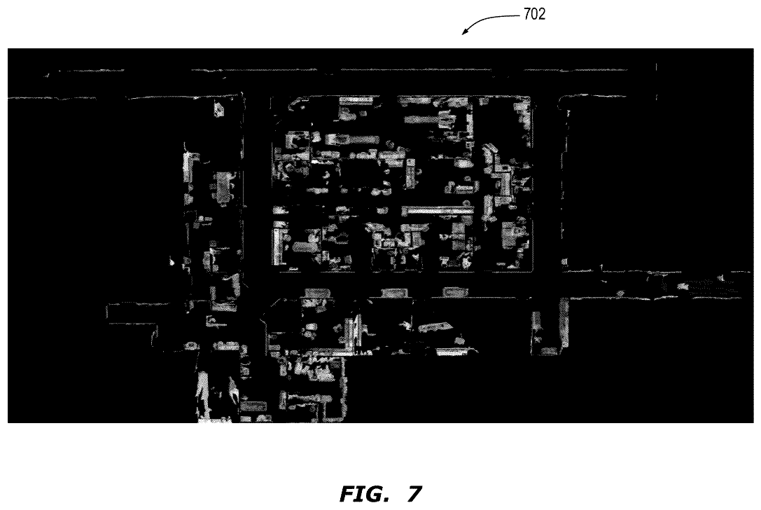

FIG. 7 illustrates an example of an item element 702 of a 2D plan view projection. The item element 702 may more prominently display items on the floor such as furniture, appliances, etc. To generate the item element 702, the system may find all points that intersect the vertical column and are less than or equal to a target height (e.g., 1.5 meters) off the floor for each vertical column in the point cloud. The system may find a point in each of the vertical columns nearest the target height (e.g., maximum height point at or below 1.5 meters), and convert the points' heights to grayscale. For instance, black may represent points with a zero height (or vertical columns with no points), white pixels may represent points with height of 1.5 meters, and different shades of gray may represent points between those heights. In some embodiments different representations of point height per vertical column may be used (e.g., heat map, color gradient image, etc.).

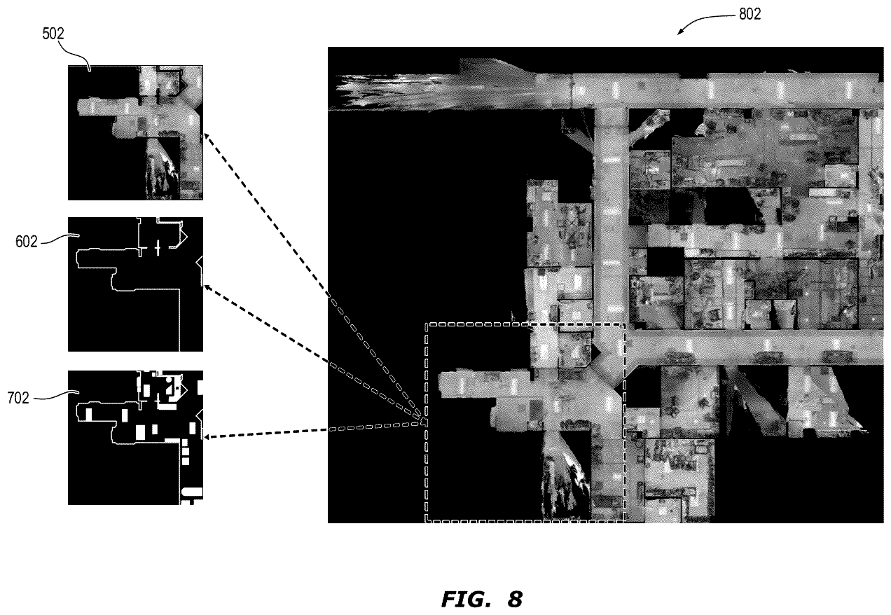

FIG. 8 illustrates an example of how a 2D plan view projection 802 may be cropped into different sections for processing by an artificial neural network. In some embodiments, the entire 2D projection 802 is not fed into the neural network. Instead, the system extract and feed a square crop 804 into the neural network. Using crops instead of the whole 2D plan view projection 802 may help with memory constraints of the neural network.

Sending cropped images instead of the whole 2D plan view projection 802 can help with memory constraints by reducing the amount of memory required to process and store the input data. By working with smaller cropped images, the network requires less memory to process and can fit within the memory limitations of the hardware or framework being used. Cropping can enable a system to process the data in smaller, manageable chunks, allowing for more efficient memory usage. The system can dynamically crop and feed images to the network during training or inference, optimizing memory usage by loading and processing only a fraction of the complete image dataset at a time. By reducing the image size through cropping, the neural network may process the input faster during both training and inference stages. With smaller input dimensions, the model can perform computations more quickly, leading to improved training times and faster inference on new unseen examples.

As shown, the crop 804 may include each element of the 2D plan view projection 802 for a specific section. For example, the illustrated crop 804 includes the color element 502, the vertical point density element 602, and the item element 702 for the bottom left of the level in the 2D plan view projection 802. This crop 804 may be fed into the neural network as part of a training dataset or as part of an inference dataset.

The entire 2D plan view projection 802 may be divided into crops using a sliding window operation. For example, a sliding window operation may divide the 2D plan view projection 802 divided into a series of crops. Each crop of the series of crops 902 may be individually fed into the neural network. The neural network may use the color element, the vertical point density element and the item element as inputs for three channels during training and when performing an inference.

In addition to the cropped 2D plan view projection 802 as an input, a training dataset also includes output examples of the neural network that are associated with the input examples. In this case, the desired output is a 2D plan view floor area mask. For the training dataset, a 2D plan view floor area mask output example may be derived from building information models. The building information model may be a pre-existing model of a building that corresponds to a point cloud. The building information model may be a digital representation of a building, infrastructure, or construction project.

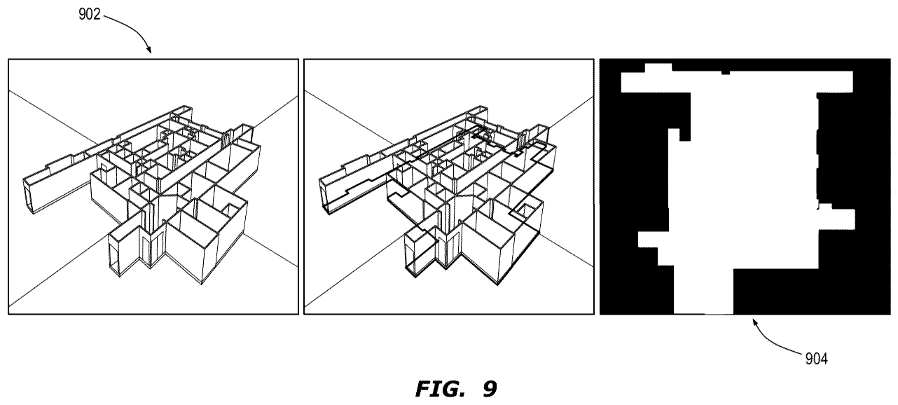

FIG. 9 illustrates an example process flow diagram for transforming a building information model 902 into a floor area mask 904. To obtain the floor area mask 902, the system or a user may determine the outline of the level's elements (e.g., floor slab) of the building information model 902. The system may project the outline in a 2D view from the top down to illustrate a floor plan footprint (e.g., mask 904). If any additional interior parts of the building information model 902 should not be considered floor area (e.g., elevator shaft), those parts may also be removed during the creation of the mask 904. The mask 904 is a 2D orthographic rasterized image of entities within the building information model 902. The system may crop the mask 904 using a sliding window to generate output examples that align with the neural network input crops.

FIG. 10 illustrates an example of a training performed using a crop 1002 of a 2D plan view projection generated from a point cloud as an input and a corresponding crop 1004 generated from a building information model as an output. As shown, the crop 1002 generated from the point cloud may include a color element, a vertical point density element, and an item element. These three elements may be used as inputs for training. The crop 1004 from the building information model may be used as the desired output during the training process.

For training, the inputs and outputs of the training dataset may be fed into the artificial neural network using batches. For example, multiple (e.g., 10-20) of these crops may be fed in at a time. The artificial neural network may be optimized using stochastic gradient descent, and the artificial neural network may be trained for a series of epochs (e.g., 10-30 epochs). For each epoch, the training data set may be fed through the artificial neural network.

During training, the data works its way through all of the layers of the artificial neural network, and the artificial neural network outputs a prediction as to what it believes is floor area and what is not. That prediction is then compared with the ground truth (e.g., crop 1004) that exists within the example outputs of the training data set. The artificial neural network is then provided feedback on that prediction. Each neural network prediction may be evaluated using a loss function (e.g., calculates prediction error). Back propagation may calculate the contribution of each neural network parameter to that loss, and the parameters are updated so as to incrementally decrease the prediction loss (e.g., error)”.

In some embodiments, the training data set may be augmented to generate additional input and output examples to improve the performance of the artificial neural network. For example, the system may use data augmentation techniques such as rotation and/or mirroring to increase the size of the dataset. In some embodiments, individual crops may be rotated and/or mirrored to increase the dataset size. In some embodiments, whole levels or buildings may be rotated and/or mirrored to increase the dataset size. In total, the training dataset may contain a number of sample input/output pairs (e.g., 100,000 sample input/output pairs).

Any kind of 2D semantic segmentation neural network architecture can be used for the artificial neural network used to generate the 2D semantically segmented mask of a building level. The optimizer used may be stochastic gradient descent with momentum. A loss function may be the sum of cross-entropy terms for each spatial position in the output mask.

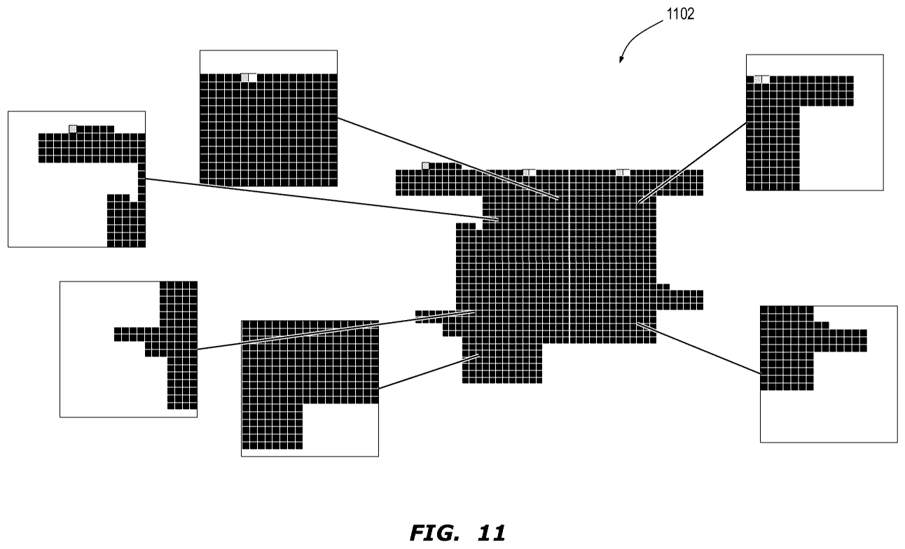

FIG. 11 illustrates an example of a set of crops being reconstituted into a 2D semantically segmented mask 1102 of a building level. The output from the artificial neural network may be combined by the system to generate the 2D semantically segmented mask 1102 using the same sliding window operation used for cropping but in reverse.

Overlapping pixels may be consolidated using majority voting. Reconstituting the series of cropped outputs into a whole floor area may involve consolidation of overlapping pixels. The cropped outputs may overlap with neighboring patches to ensure seamless reconstruction. The overlapping regions between adjacent cropped outputs may comprise duplicate pixels. These overlapping pixels may be used for accurate reconstruction and to avoid artifacts at the boundaries of the patches. To consolidate the overlapping pixels, majority voting may be applied.

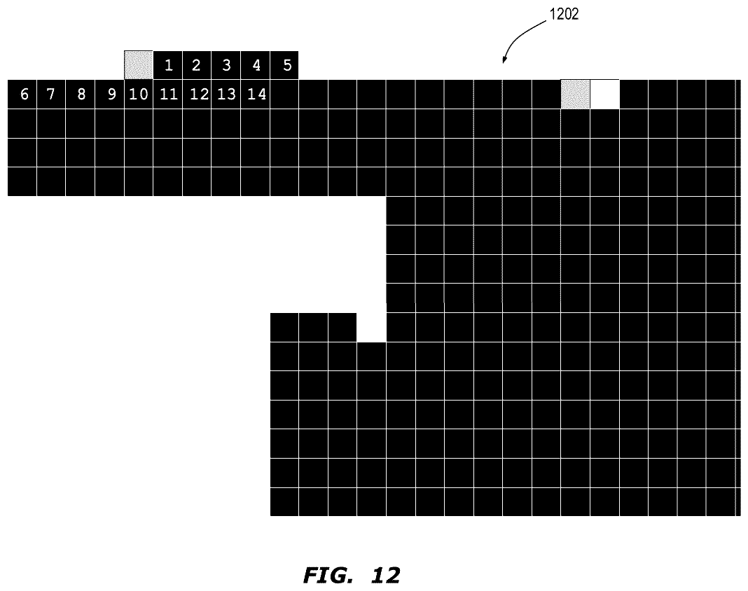

FIG. 12 illustrates an example of quantifying floor area based on a 2D semantically segmented mask 1202. As shown, the 2D semantically segmented mask 1202 may be divided into a set of pixels (e.g., pixels 1-14). The system may quantify floor area by counting the pixels of the 2D semantically segmented mask 1202 and convert the number of pixels to real world area units. The pixel to square footage may be known because this scale can be set during the initial 3D to 2D projection (e.g., setting the dimension of each vertical column).

For example, during the creation of the 2D plan view projection, a pixel size may be selected. The pixel size may correspond to the dimensions of the vertical columns used when generating the color element, the vertical point density element, and the item element of the 2D plan view projection. Accordingly, each pixel has a real world dimension that is a real world length and a real world width. For instance, each pixel may be two inches by two inches in dimension in some embodiments. The system may then count the number of pixels in the 2D semantically segmented mask 1202 and use that number of pixels and the size of the pixels to determine the square footage. The system may multiply that number of pixels by the real world dimension of each pixel. For example, if there are 200,000 pixels and the pixels are two inches by two inches, the system may calculate the area as being 800,000 square inches. The system may convert this measurement into whatever dimensions are desired (e.g., feet, square meters, etc.).

The creation and use of the neural network for level detection may be similar to the floor-area segmentation neural network, with a few differences. For instance, rather than projecting to a plan-view, the system may project the 3D digital representations to an elevation view. Further, rather than performing semantic segmentation, the system may perform object detection. In other words, rather than classifying each pixel in the input image, the system instead draws bounding boxes around each level. Once the bounding box is predicted, the system may use it to delineate all points representing a level.

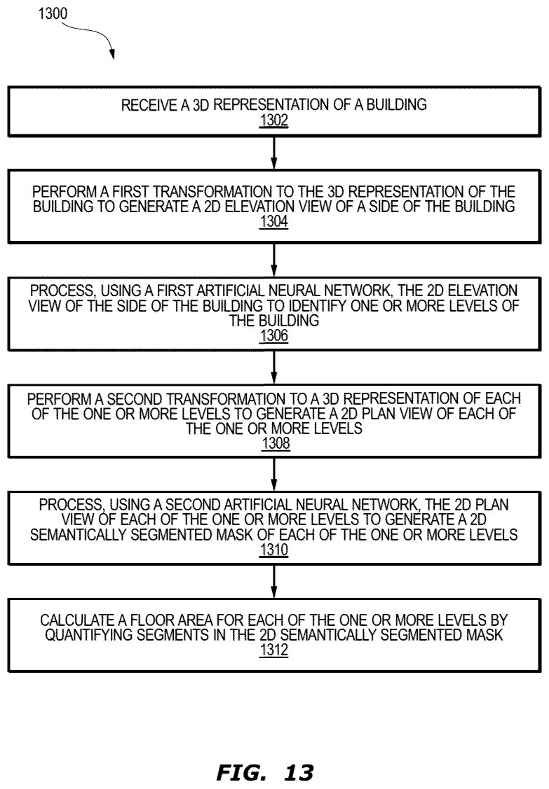

FIG. 13 illustrates a method 1300 for a floor area estimator in accordance with some embodiments. The illustrated method 1300 includes receiving 1302 a 3D representation of a building. The method 1300 further includes performing 1304 a first transformation to the 3D representation of the building to generate a 2D elevation view of a side or slice of the building. The method 1300 further comprises processing 1306, using a first artificial neural network, the 2D elevation view of the side or slice of the building to identify one or more levels of the building. In performing 1308, method 1300 performs a second transformation to a 3D representation of each of the one or more levels to generate a 2D plan view of each of the one or more levels. The method 1300 further comprises processing 1310, using a second artificial neural network, the 2D plan view of each of the one or more levels to generate 2D semantically segmented masks of each of the one or more levels. The method 1300 further comprises calculating 1312, a floor area for each of the one or more levels by quantifying segments in the 2D semantically segmented masks.

In some embodiments of the method 1300, the first artificial neural network performs object detection to generate bounding boxes corresponding to the building levels or floor slabs.

In some embodiments of the method 1300, the 2D elevation view comprises a color element and a horizontal point density element, and wherein the first artificial neural network uses the color element and the horizontal point density element as inputs for two input channels.

In some embodiments of the method 1300, the second neural network performs semantic segmentation and classifies areas of the one or more levels into floor areas and non-floor areas.

In some embodiments of the method 1300, the 2D plan view projection comprises a color element, a vertical point density element, and an item element, and wherein the second artificial neural network uses the color element, the vertical point density element, and the item element as inputs for three input channels.

In some embodiments, the method 1300 further comprises generating the color element by identifying points of the 3D representation of each of the levels that are contained within a vertical column that are contained within vertical columns across each of the one or more levels, and setting a color of an associated pixel in the 2D plan view projection as an average of those points.

In some embodiments, the method 1300 further comprises generating the vertical point density element by determining points of the 3D representation of each of the levels that are contained within vertical columns across each of the one or more levels, and setting an associated pixel to a grayscale value based on a number of points in each of the vertical columns.

In some embodiments, the method 1300 further comprises generating the vertical point density element by determining points of the 3D representation of each of the levels that are contained within vertical columns across each of the one or more levels and that are less than or equal to a target height, and setting an associated pixel to a grayscale value based on a distance of a closest point to the target height.

In some embodiments, the method 1300 further comprises processing the 2D plan view with one or more additional artificial neural networks trained and employed to detect specific categories of areas to exclude from the 2D semantically segmented mask based on a set of exclusion rules.

In some embodiments, the method 1300 further comprises: generating inputs for a training dataset by performing a sliding window crop operation to a series of training representations to generate a set of input crops; generating outputs for the training dataset by performing the sliding window crop operation to a series of building models containing building elements relevant to defining floor areas to generate a set of output crops; augmenting the training dataset by rotating and mirroring the input crops and the output crops to generate additional input-output pairs; and training the first artificial neural network and the second artificial neural network.

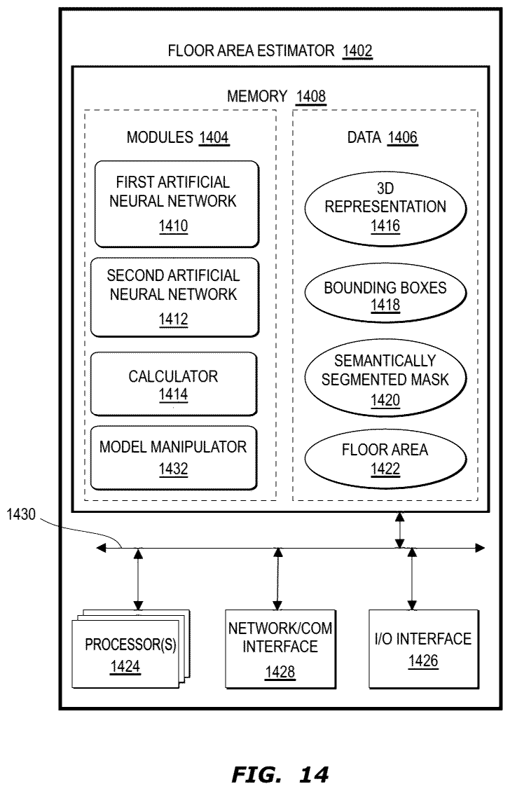

FIG. 14 is a block diagram of a floor area estimator 1402 in accordance with some embodiments. The floor area estimator 1402 may perform method 1300 of FIG. 13. The floor area estimator 1402 can include a memory 1408, one or more processors 1424, a network interface 1428, an input/output interface 1426, and a system bus 809.

The one or more processors 1424 may include one or more general purpose devices, such as an Intel®, AMD®, or other standard microprocessor. The one or more processors 804 may include a special purpose processing device, such as ASIC, SoC, SiP, FPGA, PAL, PLA, FPLA, PLD, or other customized or programmable device. The one or more processors 804 can perform distributed (e.g., parallel) processing to execute or otherwise implement functionalities of the presently disclosed embodiments. The one or more processors 1424 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The memory 1408 may include static RAM, dynamic RAM, flash memory, one or more flip-flops, ROM, CD-ROM, DVD, disk, tape, or magnetic, optical, or other computer storage medium. The memory 1408 may include a plurality of program modules 1404 and program data 1406. The memory 1408 may be local to the floor area estimator 1402, as shown, or may be distributed and/or remote relative to the floor area estimator 1402.

The program modules 1404 may include all or portions of other elements of the floor area estimator 1402. The program modules 1404 may run multiple operations concurrently or in parallel by or on the one or more processors 1424. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, subsystems and/or the like.

The modules 1404 may comprise a first artificial neural network 1410, a second artificial neural network 1412, a model manipulator 1432 and a calculator 1414. The model manipulator 1432 may perform transformations to the 3D representation 1416 to generate inputs for the first artificial neural network 1410 and second artificial neural network 1412. The first artificial neural network 1410 may generate the bounding boxes 1418. The second artificial neural network 1412 may generate the semantically segmented mask 1420. The calculator 1414 may determine the 1422 based on the floor area 1422.

The memory 1408 may also include the data 1406. Data generated by the floor area estimator 1402 may be stored on the memory 803. The data 1406 may include a 3D representation 1416, bounding boxes 1418, semantically segmented mask 1420, and floor area 1422.

The input/output interface 1426 may facilitate user interaction with one or more input devices and/or one or more output devices. The input device(s) may include a keyboard, mouse, touchscreen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. The network interface 1428 may facilitate communication with other computing devices and/or networks and/or other computing and/or communications networks.

The network interface 1428 may be equipped with conventional network connectivity, such as, for example, Ethernet (IEEE 1102.3), Token Ring (IEEE 1102.5), Fiber Distributed Datalink Interface (FDDI), or Asynchronous Transfer Mode (ATM). Further, the network interface 1428 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 1430 may facilitate communication and/or interaction between the other components of the floor area estimator 1402, including the one or more processors 1424, the memory 1408, the input/output interface 1426, and the network interface 1428.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

What is claimed is:

1. A method for a floor area estimator, the method comprising:
receiving a three-dimensional (3D) representation of a building;
identifying one or more levels of the building;
performing a transformation to a 3D representation of each of the one or more levels to generate a 2D plan view projection of each of the one or more levels;
processing, using an artificial neural network, the 2D plan view projection of each of the one or more levels to generate 2D semantically segmented masks of each of the one or more levels; and
calculating a floor area for each of the one or more levels by quantifying segments in the 2D semantically segmented masks.

2. The method of claim 1, wherein identifying the one or more levels of the building comprises:
performing a second transformation to the 3D representation of the building to generate a two-dimensional (2D) elevation view of a side or slice of the building; and
processing, using a second artificial neural network, the 2D elevation view of the side or slice of the building to identify the one or more levels of the building.

3. The method of claim 2, wherein the second artificial neural network performs object detection to generate bounding boxes corresponding to the building levels or floor slabs, and wherein the 2D elevation view comprises a color element and a horizontal point density element, and wherein the second artificial neural network uses the color element and the horizontal point density element as inputs for two input channels.

4. The method of claim 1, wherein the artificial neural network performs semantic segmentation and classifies areas of the one or more levels into floor areas and non-floor areas.

5. The method of claim 1, wherein the 2D plan view projection comprises a color element, a vertical point density element, and an item element, and wherein the artificial neural network uses the color element, the vertical point density element, and the item element as inputs for three input channels.

6. The method of claim 5, further comprising generating the color element by identifying points of the 3D representation of each of the levels that are contained within a vertical column that are contained within vertical columns across each of the one or more levels, and setting a color of an associated pixel in the 2D plan view projection as an average of those points.

7. The method of claim 5, further comprising generating the vertical point density element by determining points of the 3D representation of each of the levels that are contained within vertical columns across each of the one or more levels, and setting an associated pixel to a grayscale value based on a number of points in each of the vertical columns.

8. The method of claim 5, further comprising generating the vertical point density element by determining points of the 3D representation of each of the levels that are contained within vertical columns across each of the one or more levels and that are less than or equal to a target height, and setting an associated pixel to a grayscale value based on a distance of a closest point to the target height.

9. The method of claim 1, further comprising processing the 2D plan view with one or more additional artificial neural networks trained and employed to detect specific categories of areas to exclude from the 2D semantically segmented mask based on a set of exclusion rules.

10. The method of claim 1, further comprising:
generating inputs for a training dataset by performing a sliding window crop operation to a series of training representations to generate a set of input crops;
generating outputs for the training dataset by performing the sliding window crop operation to a series of building models comprising building elements relevant to defining floor areas to generate a set of output crops;
augmenting the training dataset by rotating and mirroring the input crops and the output crops to generate additional input-output pairs; and
training the artificial neural network using the augmented training dataset.

11. A computing apparatus comprising:
a processor; and
a memory storing instructions that, when executed by the processor, configure the apparatus to:
receive a three-dimensional (3D) representation of a building,
identify one or more levels of the building;
perform a transformation to a 3D representation of each of the one or more levels to generate a 2D plan view projection of each of the one or more levels;
process, using an artificial neural network, the 2D plan view projection of each of the one or more levels to generate 2D semantically segmented masks of each of the one or more levels; and
calculate a floor area for each of the one or more levels by quantifying segments in the 2D semantically segmented masks.

12. The computing apparatus of claim 11, wherein to identifying the one or more levels of the building comprises:
performing a second transformation to the 3D representation of the building to generate a two-dimensional (2D) elevation view of a side or slice of the building; and
processing, using a second artificial neural network, the 2D elevation view of the side or slice of the building to identify the one or more levels of the building.

13. The computing apparatus of claim 12, wherein the first artificial neural network performs object detection to generate bound boxes corresponding to the building levels or floor slabs, and wherein the 2D elevation view comprises a color element and a horizontal point density element, and wherein the first artificial neural network uses the color element and the horizontal point density element as inputs for two input channels.

14. The computing apparatus of claim 11, wherein the artificial neural network performs semantic segmentation and classifies areas of the one or more levels into floor areas and non-floor areas.

15. The computing apparatus of claim 11, wherein the 2D plan view projection comprises a color element, a vertical point density element, and an item element, and wherein the artificial neural network uses the color element, the vertical point density element, and the item element as inputs for three input channels.

16. The computing apparatus of claim 15, wherein the instructions further configure the apparatus to generate the color element by identifying points of the 3D representation of each of the levels that are contained within a vertical column that are contained within vertical columns across each of the one or more levels, and setting a color of an associated pixel in the 2D plan view projection as an average of those points.

17. The computing apparatus of claim 15, wherein the instructions further configure the apparatus to generate the vertical point density element by determining points of the 3D representation of each of the levels that are contained within vertical columns across each of the one or more levels, and setting an associated pixel to a grayscale value based on a number of points in each of the vertical columns.

18. The computing apparatus of claim 15, wherein the instructions further configure the apparatus to generate the vertical point density element by determining points of the 3D representation of each of the levels that are contained within vertical columns across each of the one or more levels and that are less than or equal to a target height, and setting an associated pixel to a grayscale value based on a distance of a closest point to the target height.

19. The computing apparatus of claim 11, wherein the instructions further configure the apparatus to process the 2D plan view with one or more additional artificial neural networks trained and employed to detect specific categories of areas to exclude from the 2D semantically segmented mask based on a set of exclusion rules.

20. A non-transitory computer-readable storage medium, the computer-readable storage medium including instructions that when executed by a computer, cause the computer to:
receive a three-dimensional (3D) representation of a building;
identify one or more levels of the building;
perform a transformation to a 3D representation of each of the one or more levels to generate a 2D plan view projection of each of the one or more levels;
process, using an artificial neural network, the 2D plan view projection of each of the one or more levels to generate 2D semantically segmented masks of each of the one or more levels;
calculate a floor area for each of the one or more levels by quantifying segments in the 2D semantically segmented masks.
